(19) United States
(12) Patent Application Publication
(10) Pub. No.: US 2017/0220130 A1
(43) Pub. Date: Aug. 3, 2017

(54) MOBILE PHONE

(71) Applicant: KYOCERA Corporation, Kyoto (JP)

(72) Inventors: Hisae MORITA, Yokohama-shi (JP); Kazuki MORITA, Tokyo (JP)

(73) Assignee: KYOCERA Corporation, Kyoto (JP)

(21) Appl. No.: 15/420,212

(22) Filed: Jan. 31, 2017

(30) Foreign Application Priority Data
Feb. 1, 2016 (JP) 2016-017410

(51) Int. Cl. G06F 3/023; H04M 1/23; H04M 1/02

(52) U.S. Cl. CPC G06F 3/0238; H04M 1/0264; H04M 1/236; G06F 3/0489

(57) ABSTRACT

A feature phone type mobile phone includes a physical key and a display that displays a screen. A function to cause a notification screen to be displayed is always allocated to the physical key to allow the notification screen to be displayed on the screen while any screen is being displayed on the display.

### TECHNICAL FIELD

This disclosure relates to a mobile phone. In greater detail, this disclosure relates to a feature phone type mobile phone.

### BACKGROUND

Some smartphones that are now commercially available display a notification screen, on a display provided with a touch panel, in response to the user performing a slide (or flick) operation from the upper edge of the screen towards the bottom of the screen.

### CITATION LIST

### Patent Literature

PTL 1: JP 2014-67247 A

### SUMMARY

A feature phone type mobile phone according to this disclosure includes:

a display configured to display a screen; and

a physical key;

such that a function to cause a notification screen to be displayed is always allocated to the physical key to allow the notification screen to be displayed on the screen while any screen is being displayed on the display.

### BRIEF DESCRIPTION OF THE DRAWINGS

In the accompanying drawings:

FIG. 1 is an external view of a mobile phone according to one of the embodiments of this disclosure;

FIG. 2 is a block diagram schematically illustrating the structure of a mobile phone according to one of the embodiments of this disclosure;

FIG. 3 illustrates an example of operations of a mobile phone according to one of the embodiments of this disclosure;

FIG. 4 illustrates allocation of features to the keys in the mobile phone illustrated in FIG. 3;

FIG. 5 illustrates an example of operations of a mobile phone according to one of the embodiments of this disclosure;

FIG. 6 illustrates another example of operations of a mobile phone according to one of the embodiments of this disclosure;

FIG. 7 illustrates allocation of features to the keys in the mobile phone illustrated in FIG. 6;

FIG. 8 illustrates another example of operations of a mobile phone according to one of the embodiments of this disclosure; and

FIG. 9 illustrates allocation of features to the keys in the mobile phone illustrated in FIG. 8.

### DETAILED DESCRIPTION

In a typical smartphone, however, different operation screens (GUI) can be configured in accordance with the screens that are displayed. On each GUI, not only can the positions at which keys or icons are displayed be varied, but also the functions and the like of the keys or icons can be varied. No matter what type of screen (or GUI) is displayed on such a display, however, a notification screen can be displayed on many smartphones in response to the user performing a slide operation or the like from the upper edge of the screen towards the bottom of the screen. In this way, on many smartphones, the notification screen can be displayed with the above-described operation no matter what screen is shown on the display. Many feature phone type mobile phones, on the other hand, are not provided with a touch panel. Furthermore, many feature phone type mobile phones have few physical keys. Therefore, on feature phone type mobile phones, the functions allocated to the physical keys typically differ in accordance with factors such as what is being shown on the display and/or the mode of the mobile phone. Feature phone type mobile phones, therefore, cannot display a particular screen on any other screen, as smartphones can. Accordingly, even if a feature phone type mobile phone is provided with a notification feature, this notification feature cannot be implemented in a user-friendly way as on a smartphone.

In addition to smartphones, if mobile phones such as feature phones could also implement an easy-to-operate notification function, feature phone type mobile phones would become more convenient.

It would therefore be helpful to provide a more convenient feature phone type mobile phone.

According to an embodiment of this disclosure, a feature phone type mobile phone can be made more convenient.

The following describes an embodiment of this disclosure with reference to the drawings.

In the embodiment described below, a folding feature phone (flip phone or clamshell phone) is described as an example of a feature phone type mobile phone. Embodiments of this disclosure, however, are not limited to folding phones and may be another type of feature phone, such as a slide phone that is slid to reveal a keyboard, a bar phone (straight phone), or the like.

For example an OS, such as Android® (Android is a registered trademark in Japan, other countries, or both), that supports operations on a touch panel (touchscreen) provided integrally with the display is assumed to be installed on a feature phone type mobile phone according to this embodiment, but the mobile phone according to this embodiment is not provided with a touchscreen and is operated for example by physical keys. A feature phone type mobile phone according to this embodiment may also be a mobile phone that is provided with a touchscreen and accepts input via the touchscreen while also allowing similar operations to be performed by physical keys. In this case, the feature phone type mobile phone according to this embodiment is not limited to allowing all of the operations via the touchscreen to be performed by physical keys and may instead only allow some of the operations via the touchscreen to be performed by physical keys as well.

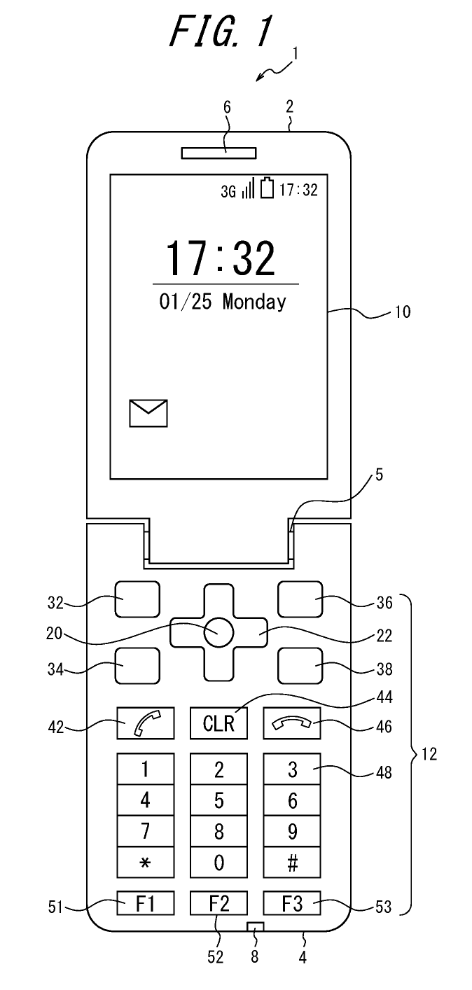

FIG. 1 is an external view of a mobile phone according to one of the embodiments of this disclosure.

As illustrated in FIG. 1, the feature phone type mobile phone 1 according to this embodiment is a folding mobile phone in which an upper housing 2 and a lower housing 4 are connected by a hinge 5. In this mobile phone 1, the upper housing 2 and the lower housing 4 can, for example, be folded with the hinge 5 as the valley of the fold. Since the external structure of the mobile phone 1 can be similar to that of a well-known folding feature phone type mobile phone, a more detailed explanation is omitted.

As illustrated in FIG. 1, the mobile phone 1 includes a speaker 6 and display 10 on the upper housing 2 side. On the lower housing 4 side, the mobile phone 1 also includes a microphone 8 and a physical key section (keyboard) 12 configured by various types of physical keys. The speaker 6 outputs voice to the user's ear during a phone call, and the microphone 8 acquires voice emitted from the user's mouth during a phone call. Since the speaker 6 and the microphone 8 may be similar to those used in a typical mobile phone, a more detailed explanation is omitted. The physical key section 12 detects input from the user who operates the mobile phone 1.

The display 10 is a display device such as a liquid crystal display, an organic EL display, an inorganic EL display, or the like. The display 10 may be provided with a light source or light-emitting element used as a backlight. The display 10 displays a variety of information to the user operating the mobile phone 1, such as characters, symbols, images, objects for operation (icons), and the like.

The physical key section 12 includes a center key (enter key) 20, a direction key (cursor key) 22, a menu key 32, a mail key 34, a camera key 36, a web key 38, a talk key 42, a clear key 44, a hang-up/power key 46, numeric keys 48, and three function keys (first function key 51, second function key 52, and third function key 53). The numeric keys 48 include number keys from 0 to 9 and other symbol keys. The keys constituting the physical key section 12 may be configured as push-button type automatic return switches or the like. Since the functions of the keys constituting the physical key section 12 may be similar to those of a typical mobile phone, a more detailed explanation is omitted. In FIG. 1, the characters or symbols stamped on the key tops of the keys constituting the physical key section 12 are simplified or omitted as appropriate.

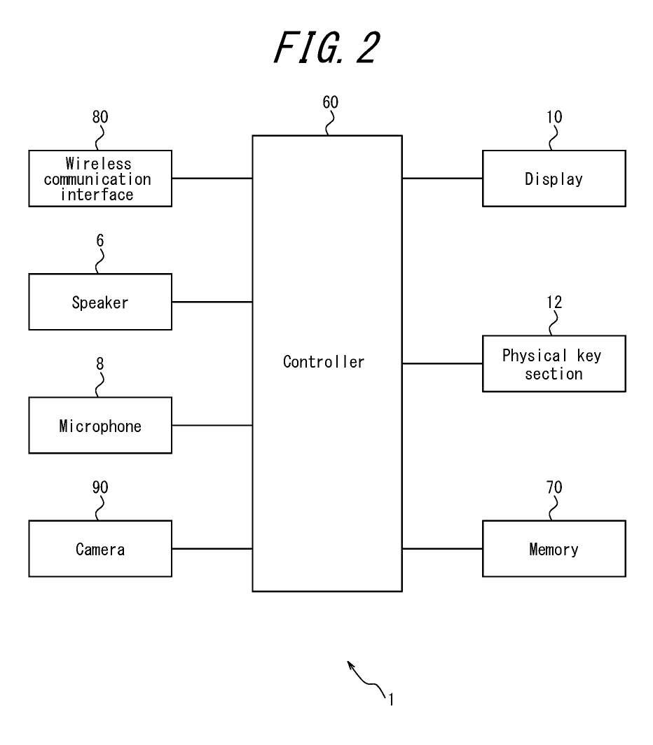

FIG. 2 is a block diagram schematically illustrating the structure of a mobile phone according to one of the embodiments of this disclosure.

As illustrated in FIG. 2, in terms of functionality, the mobile phone 1 includes the display 10, the physical key section 12, and a controller 60. As described with reference to FIG. 1, the mobile phone 1 also includes the speaker 6 and the microphone 8 in order to implement the functions of a mobile phone. As illustrated in FIG. 2, the mobile phone 1 also includes a memory 70 and a wireless communication interface 80. Furthermore, the mobile phone 1 may include other components as appropriate, such as a camera 90 for capturing photographs or video.

The controller 60 may be configured by a processor that, starting with the functional blocks of the mobile phone 1, controls and manages the mobile phone 1 overall. The controller 60 may be a processor such as a CPU that executes a program prescribing control procedures. The program executed by the controller 60 may, for example, be stored in the memory 70, on an external storage medium, or the like.

The memory 70 may be configured by a storage apparatus such as a semiconductor memory. The memory 70 stores a variety of information, programs for causing the mobile phone 1 to operate, and the like and also functions as a working memory. The memory 70 may, for example, be configured to include RAM and ROM or the like. The memory 70 for example stores certain programs corresponding to applications to cause the controller 60 to execute particular functions, and also stores text data for e-mail (mail), image data, and the like.

The wireless communication interface 80 for example connects to a communication network by wireless communication over an antenna with a wireless communication base station and executes functions for the mobile phone 1 to place a phone call, engage in data communication, and like. Since the wireless communication interface 80 can be configured similarly as the components for implementing the wireless communication function of a regular smartphone or feature phone, a more detailed explanation is omitted.

The camera 90 is a component for implementing the function of a digital camera that can capture still images or video. The data of the still images or video captured by the camera 90 may, for example, be saved in the memory 70. Since the camera 90 can be configured in a similar way as the camera provided in a regular smartphone or feature phone, a more detailed explanation is omitted.

Next, operations of the mobile phone 1 according to this embodiment are described.

The mobile phone 1 according to this embodiment makes a feature phone type mobile phone more convenient by implementing an easy-to-operate notification function. As described above, the notification may be for one or more pieces of information in order to notify the user for example of a missed call, receipt of e-mail, or the like. The notification screen may also refer to a screen that can display the above-described notification and setting icons or the like. The notification screen is typically a screen for displaying one or more notifications. Even when there is currently no notification, though, a notification screen to inform the user that there are no notifications may be displayed. In this embodiment, it is assumed that at the point in time at which there occurs a predetermined event for which notification should be displayed, a notification can be displayed on the lock screen.

As described above, feature phone type mobile phones cannot display a particular screen from any other screen, as smartphones can. Accordingly, even if a feature phone type mobile phone is provided with a notification feature, this notification feature cannot be implemented in a user-friendly way as on a smartphone.

Therefore, in this embodiment, a function to display a notification screen is allocated to a physical key, and even if the display on the display 10 and/or the mode of the mobile phone 1 changes, the allocation of the function to the physical key is configured not to change. In other words, in this embodiment, a function to display the notification screen is always allocated to the same physical key regardless of the display on the display 10 and/or the mode of the mobile phone 1. In this case, allocating the function to display the notification screen to a physical key that is used with high frequency to execute another function could be inconvenient when the user wishes to execute the other function. Therefore, in this embodiment, the function to display the notification screen can for example be allocated to one of the three function keys (first function key 51, second function key 52, and third function key 53). As an example, the following describes the case of the function to display the notification screen being allocated to the second function key 52, which is a physical key.

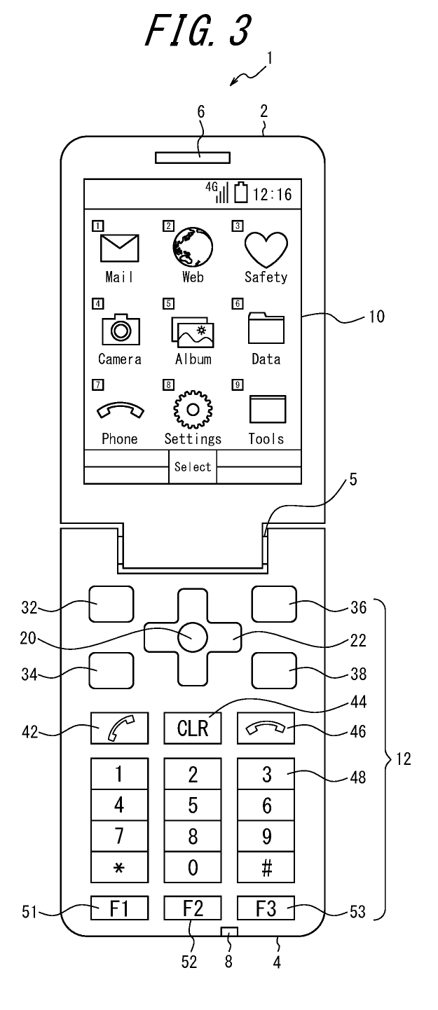

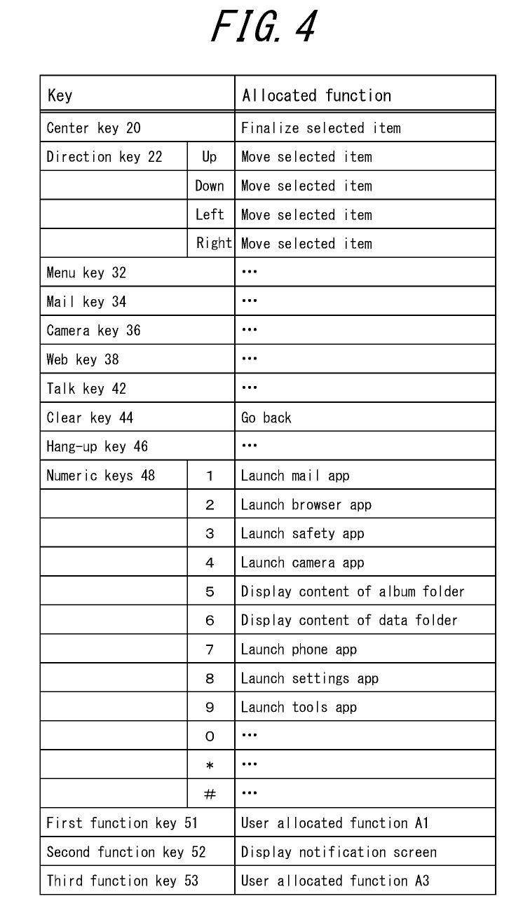

FIG. 3 displays an example of a screen displayed on the display 10 in the mobile phone 1. FIG. 4 illustrates an example of functions allocated to the keys constituting the physical key section 12 when the screen illustrated in FIG. 3 is displayed on the display 10.

FIG. 3 illustrates a state in which a menu screen is displayed on the display 10 of the mobile phone 1. As illustrated in FIG. 3, a variety of applications installed on the mobile phone 1 can be launched from the menu screen on the mobile phone 1. For example, in the state in which the menu screen is displayed in FIG. 3, an application to launch can be selected by operating the direction key 22, and the selected application can be launched by operating the center key 20. In the state in which the menu screen illustrated in FIG. 3 is displayed, for example by operating the number keys constituting the numeric keys 48, applications corresponding to the number keys can also be selected and launched.

FIG. 4 illustrates functions allocated to the keys constituting the physical key section 12 in order to implement operations corresponding to the above-described operations on the menu screen displayed on the display 10. In FIG. 4, the keys constituting the physical key section 12 are displayed in correspondence with the functions allocated to the keys. In this embodiment, in order to implement the above-described operations, the function of moving the corresponding selected item in various directions is allocated to the direction key 22, as illustrated in FIG. 4. A function to finalize the selected item is allocated to the center key 20, such as a function to launch the selected application (or in an album folder, data folder, or the like, a function to display the contents of the folder). Furthermore, a function to launch the corresponding application (or in an album folder, data folder, or the like, a function to display the contents of the folder) is allocated to each of the number keys constituting the numeric keys 48. The allocation of functions for the keys illustrated in FIG. 4 is only an example, and other allocations may be adopted. In FIG. 4, the allocation of functions for a portion of the keys is abbreviated.

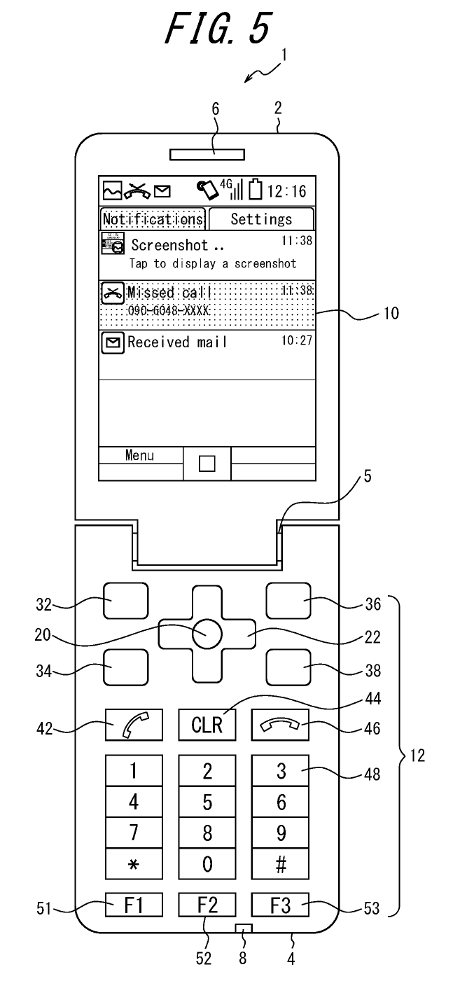

In this embodiment, as illustrated in FIG. 4, a function to display a notification screen when the menu screen is displayed on the display 10 is allocated to the second function key 52. Accordingly, in this embodiment, when a user operation to press the second function key 52 is detected, the controller 60 of the mobile phone 1 executes a function to display the notification screen. In other words, while in a state of displaying the menu screen as illustrated in FIG. 3, the mobile phone 1 according to this embodiment displays a notification screen such as the one illustrated in FIG. 5 upon detecting that the user has pressed the second function key 52. In FIG. 5, a notification screen for a missed call and receipt of e-mail is displayed on the display 10 of the mobile phone 1.

FIG. 4 shows a user allocated function A1 being allocated to the first function key 51 and a user allocated function A3 being allocated to the third function key 53. In this way, predetermined functions A1 and A3 or the like that the user often uses can be allocated to the first function key 51 and the third function key 53. Even in this case, when a notification function is included in the mobile phone 1, a configuration may be adopted not to allow a function other than the function to display the notification screen to be allocated to the second function key 52.

In this way, with the mobile phone 1 according to this embodiment, a notification screen can be displayed with a simple operation on a feature phone type mobile phone even when a menu screen is being displayed.

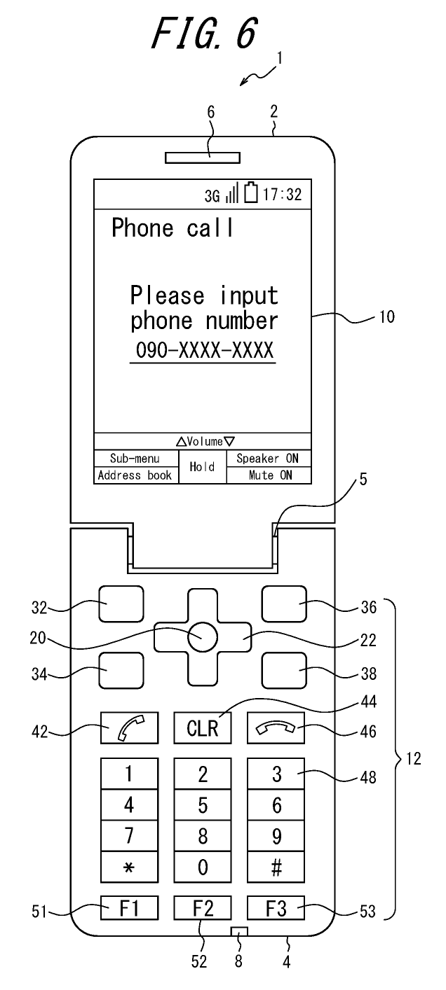

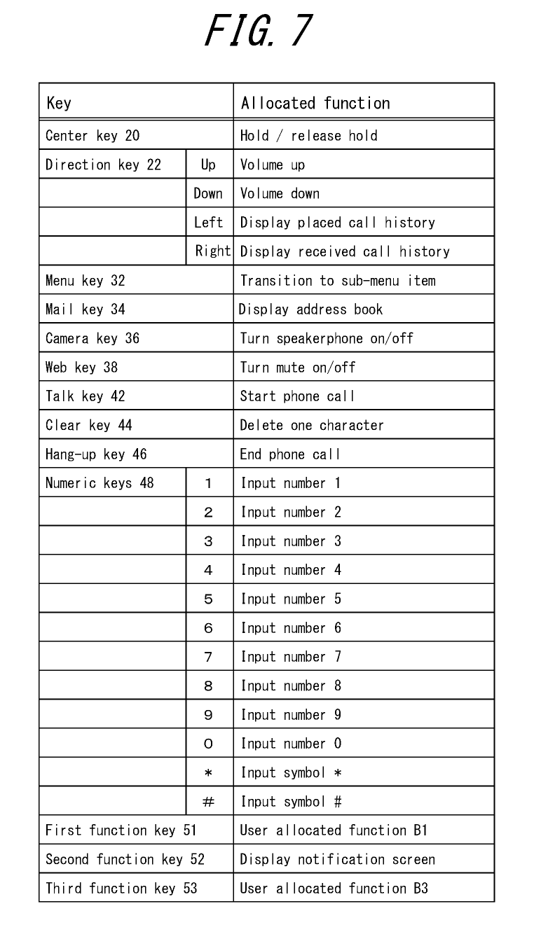

FIG. 6 displays another example of a screen displayed on the display 10 in the mobile phone 1. FIG. 7 illustrates an example of functions allocated to the keys constituting the physical key section 12 when the screen illustrated in FIG. 6 is displayed on the display 10.

FIG. 6 illustrates a state in which a phone call screen is displayed on the display 10 of the mobile phone 1. As illustrated in FIG. 6, on the phone call screen of the mobile phone 1, for example the other party's phone number can be input using the number keys constituting the numeric keys 48. On the phone call screen of the mobile phone 1, for example phone number data registered in advance in the address book can also be read by pressing the mail key 34.

FIG. 7 illustrates functions allocated to the keys constituting the physical key section 12 in order to implement operations corresponding to the above-described operations on the phone call screen displayed on the display 10. In FIG. 7 as well, the keys constituting the physical key section 12 are displayed in correspondence with the functions allocated to the keys. In this embodiment, in order to implement the above-described operations, the function of inputting the corresponding number is allocated to the number keys constituting the numeric keys 48, as illustrated in FIG. 7. The function of displaying the address book is allocated to the mail key 34.

In this embodiment, as illustrated in FIG. 7, a function to display a notification screen when the phone call screen is displayed on the display 10 is allocated to the second function key 52. Accordingly, in this embodiment, when a user operation to press the second function key 52 is detected here as well, the controller 60 of the mobile phone 1 executes a function to display the notification screen. In other words, while in a state of displaying the phone call screen as illustrated in FIG. 6, the mobile phone 1 according to this embodiment displays a notification screen such as the one illustrated in FIG. 5 upon detecting that the user has pressed the second function key 52.

FIG. 7 shows a user allocated function B1 being allocated to the first function key 51 and a user allocated function B3 being allocated to the third function key 53. In this way, for example functions B1 and B3 or the like that are predetermined functions that the user often uses and that differ from A1 and A3 can be allocated to the first function key 51 and the third function key 53. Even in this case, when a notification function is included in the mobile phone 1, a configuration may be adopted not to allow a function other than the function to display the notification screen to be allocated to the second function key 52.

In this way, with the mobile phone 1 according to this embodiment, a notification screen can be displayed with a simple operation on a feature phone type mobile phone even when a phone call screen is being displayed.

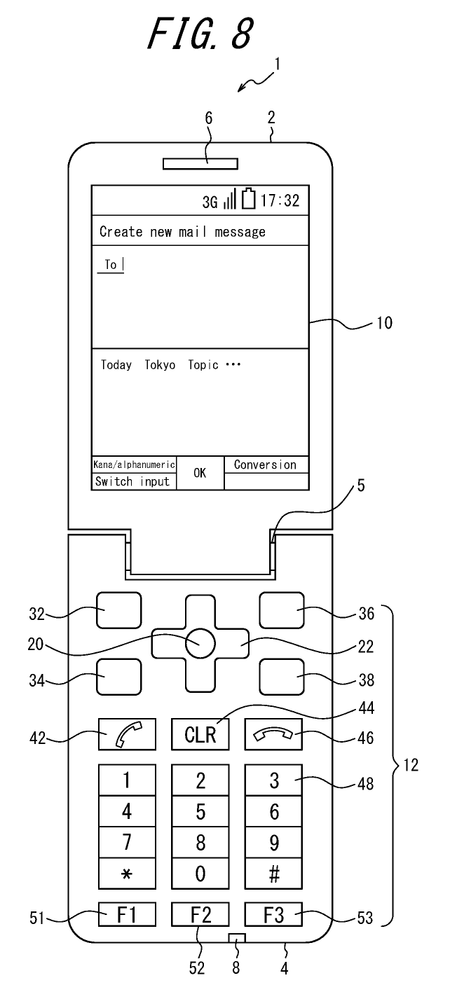

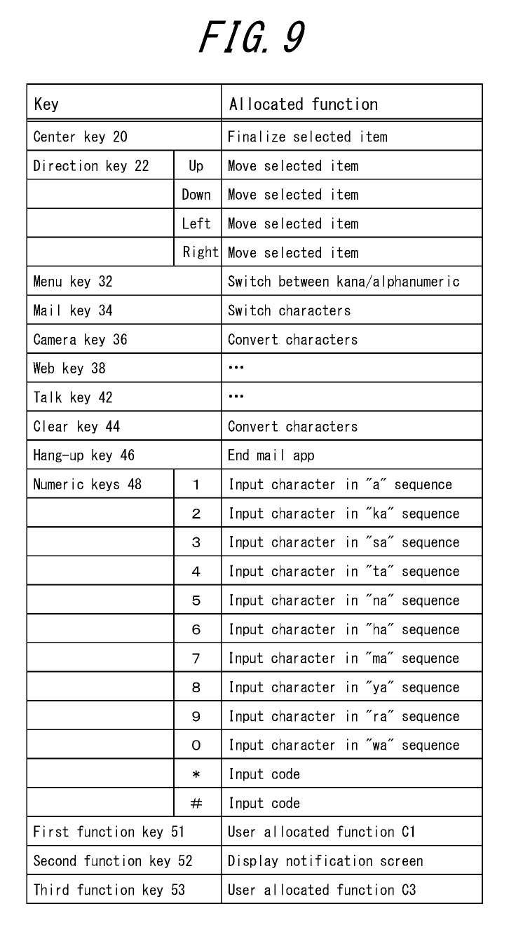

FIG. 8 displays another example of a screen displayed on the display 10 in the mobile phone 1. FIG. 9 illustrates an example of functions allocated to the keys constituting the physical key section 12 when the screen illustrated in FIG. 8 is displayed on the display 10.

FIG. 8 illustrates a state in which a screen for composing a new mail message is displayed on the display 10 of the mobile phone 1. As illustrated in FIG. 8, on the mail composition screen of the mobile phone 1, for example the characters of a mail message can be input using the number keys constituting the numeric keys 48. On the mail composition screen of the mobile phone 1, for example the user can switch between input of kana characters and alphanumeric characters by pressing the menu key 32.

FIG. 9 illustrates functions allocated to the keys constituting the physical key section 12 in order to implement operations corresponding to the above-described operations on the mail composition screen displayed on the display 10. In FIG. 9 as well, the keys constituting the physical key section 12 are displayed in correspondence with the functions allocated to the keys. In this embodiment, in order to implement the above-described operations, the function of inputting characters of the corresponding row is allocated to the number keys constituting the numeric keys 48, as illustrated in FIG. 9. The function of switching between kana and alphanumeric input is also allocated to the menu key 32.

In this embodiment, as illustrated in FIG. 9, a function to display a notification screen when the mail composition screen is displayed on the display 10 is allocated to the second function key 52. Accordingly, in this embodiment, when a user operation to press the second function key 52 is detected here as well, the controller 60 of the mobile phone 1 executes a function to display the notification screen. In other words, while in a state of displaying the mail composition screen as illustrated in FIG. 8, the mobile phone 1 according to this embodiment displays a notification screen such as the one illustrated in FIG. 5 upon detecting that the user has pressed the second function key 52.

FIG. 9 shows a user allocated function C1 being allocated to the first function key 51 and a user allocated function C3 being allocated to the third function key 53. In this way, for example functions C1 and C3 or the like that are predetermined functions that the user often uses and that differ from A1 and A3 and from B1 and B3 can be allocated to the first function key 51 and the third function key 53. Even in this case, when a notification function is included in the mobile phone 1, a configuration may be adopted not to allow a function other than the function to display the notification screen to be allocated to the second function key 52.

In this way, with the mobile phone 1 according to this embodiment, a notification screen can be displayed with a simple operation on a feature phone type mobile phone even when a mail composition screen is being displayed.

For reasons such as security and prevention of erroneous operation, feature phones such as the mobile phone 1 are often configured so that for example when the power is turned on, or the phone is opened from the folded state, a lock screen such as the one illustrated in FIG. 1 is displayed. On such a lock screen, operations other than limited operations are typically invalid. While in the state of displaying such a lock screen as well, the mobile phone 1 according to this embodiment may display a notification screen such as the one illustrated in FIG. 5 upon detecting that the user has pressed the second function key 52. In this case, even when the lock screen is displayed on the display 10, the function to display the notification screen on the display 10 is allocated to the second function key 52, and input to the second function key 52 is not invalidated.

On the other hand, in a state in which such a lock screen is displayed, the number of physical keys allowed to be operated (i.e. for which operation is not invalid) is preferably reduced insofar as possible in keeping with the purpose of the lock screen. Accordingly, while in the state of displaying such a lock screen, the mobile phone 1 according to this embodiment may be configured not to display a notification screen such as the one illustrated in FIG. 5. In this case, a configuration may be adopted so that when the lock screen is displayed on the display 10, the function to display the notification screen on the display 10 is not allocated to the second function key 52. Alternatively, a configuration may be adopted so that when the lock screen is displayed on the display 10, the function to display the notification screen on the display 10 is still allocated to the second function key 52, but input to the second function key 52 is invalid.

As described above, the mobile phone 1 according to this embodiment is configured so that a function to cause a notification screen to be displayed is always allocated to the physical key 52 to allow the notification screen to be displayed on the screen while any screen is being displayed on the display 10. The mobile phone 1 according to this embodiment may be configured to allow the notification screen to be displayed on the screen while any screen other than a lock screen is displayed on the display 10. Therefore, the mobile phone 1 according to this embodiment may be configured so that, at a time other than when a lock screen is being displayed, the function to cause the notification screen to be displayed is always allocated to the physical key 52.

Also, the mobile phone 1 according to this embodiment may be configured so that while a lock screen is being displayed on the display 10, the function to cause the notification screen to be displayed is not allocated to the physical key 52. The mobile phone 1 according to this embodiment may also be configured to invalidate the physical key 52 while a lock screen is being displayed on the display 10.

In this way, with the mobile phone 1 according to this embodiment, a notification screen can be displayed with a simple operation on a feature phone type mobile phone no matter what kind of screen is being displayed on the display 10. Therefore, with the mobile phone 1 according to this embodiment, a feature phone type mobile phone can be made more convenient.

The above embodiment provides an example of a configuration in which the function to display the notification screen is always allocated to the same physical key (second function key 52). Embodiments of this disclosure are not, however, limited to such a configuration, and by user setting, the function to display the notification screen may always be allocated to any physical key.

Also, while the above embodiment provides an example of a configuration in which the function to display the notification screen is always allocated to the same physical key (second function key 52), this example is not limiting. For example, in the above embodiment, a first function to display the notification screen and a different second function (for example, a function to display a screen other than the notification screen) may always be allocated to the same physical key (second function key 52), and the first function and second function may be executed depending on a difference in the operation on the second function key 52. In this case, for example the mobile phone 1 may execute one of the first function and second function when the second function key 52 is pressed and then released within a predetermined time (short press) and execute the other one of the first function and second function when the second function key 52 is pressed and not released within a predetermined time (long press).

Although this disclosure is based on the accompanying drawings and examples, it is to be noted that various changes and modifications will be apparent to those skilled in the art based on this disclosure. Therefore, such changes and modifications are to be understood as included within the scope of this disclosure. For example, the functions and the like included in the various functional components, means, and steps may be reordered in any logically consistent way. Furthermore, functional components or steps may be combined into one or divided. The above embodiments of this disclosure are not limited to being implemented precisely as described and may be implemented by combining or partially omitting the features thereof.

1. A feature phone type mobile phone, comprising:
a display configured to display a screen; and
a physical key;
wherein a function to cause a notification screen to be displayed is always allocated to the physical key to allow the notification screen to be displayed on the screen while any screen is being displayed on the display.

2. The mobile phone of claim 1, wherein at a time other than when a lock screen is being displayed, the function to cause the notification screen to be displayed is always allocated to the physical key to allow the notification screen to be displayed on the screen while any screen other than the lock screen is being displayed on the display.

3. The mobile phone of claim 2, wherein the function to cause the notification screen to be displayed is not allocated to the physical key while a lock screen is being displayed on the display.

4. The mobile phone of claim 1, wherein the physical key is invalidated while a lock screen is being displayed on the display.

5. The mobile phone of claim 2, wherein the physical key is invalidated while a lock screen is being displayed on the display.
